(19) United States
(12) Patent Application Publication
(10) Pub. No.: US 2004/0114772 A1
(43) Pub. Date: Jun. 17, 2004

(54) Method and system for transmitting and/or receiving audio signals with a desired direction

(76) Inventor: David Zlotnick, Tel Aviv (IL)

Correspondence Address: NATH & ASSOCIATES, 1030 15th STREET, 6TH FLOOR, WASHINGTON, DC, 20005, US

(21) Appl. No.: 10/472,599

(22) PCT Filed: Mar. 21, 2002
(86) PCT No.: PCT/IL02/00234

(51) Int. Cl. H04R 3/00

(52) U.S. Cl. 381/92

(57) ABSTRACT

A method and system are presented for carrying out at least one of the following: a process of transmitting acoustic signals from an acoustic transmitting array in a desired direction towards a subject location, and a process of receiving acoustic signals propagating in a desired direction from a subject location by an acoustic receiving array. Data indicative of the desired direction is provided and utilized for processing collected signals to be transmitted as acoustic signals through the transmitting array, and/or processing signals collected by the receiving array. The processing is based on a selected wavelet packet transform model. An output signal resulting from the processing is shaped such that maximal energy of the output signal is substantially that of the desired direction.

### FIELD OF THE INVENTION

This invention is generally in the field of transmission/receiving of acoustic signals and relates to a method and system for transmitting and/or receiving acoustic signals in and/or from a desired direction. The invention is particularly useful with a communication device, such as a phone device, for increasing the directionality of transmitting and receiving acoustic signals to and from a subject location, voice operated system such a computer program as well as television and other audio sets.

### BACKGROUND OF THE INVENTION

Existing approaches to provide people with a convenient way of communicating with a distant person through a voice communication device, such as a phone device (e.g., mobile phone), personal computer or Palm device, typically utilize one of three main alternative techniques:

(1) Attaching the device itself or a headset thereof including a speaker and a microphone to the person's head;

(2) Using an earphone and a microphone unit connected to the base of the communication device through wires or wireless; and (3) Communicating via a speaker and a microphone located on the device, the device being in the vicinity of the user.

The first technique either requires a spare hand, or limits the speaker's free movement. Furthermore, a mobile phone is a source of emits? radiation that is suspected to be hazardous. The second technique is also inconvenient because a wired earphone and microphone unit has the same limitation of movement, while a wireless unit is clumsy and may be unsafe due to its RF transmission output The third technique suffers from such disadvantages as high sensitivity to background noise, no privacy for the speakers, and a low quality of sound for both parties.

Techniques aimed at directional signal reception have been developed, and are disclosed, for example in the following patens:

U.S. Pat. No. 5,901,232 discloses a technique for detecting the position (coordinates) of an external sound source and pointing (rotating) a paraboloid microphone/speaker towards the detected position.

U.S. Pat. No. 5,657,393 discloses a device having several microphones and utilizing enhancement of an external sound signal received by the microphones. The device utilizes a suitable time delay to each microphone channel to compensate for the difference in distance, and a propagation delay from the sound source to each microphone channel. This is implemented by reading the samples of the different microphone channels from a memory at different subsequent periods in accordance with the desired delay. An amplitude distributor circuit is used to modify the digitized amplitudes of the outputs of the sub-array to reduce the beam side-lobe levels.

U.S. Pat. No. 5,121,426 discloses a loudspeaker telephone station (speakerphone) that includes a loudspeaker and one or more directional microphones within the same housing station to overcome the creation of sustained oscilation (“singing”), emerging from the proximity between the loudspeaker and the microphones in the system. The microphones have a polar response characteristic that includes a major lobe, one or more side-lobes, and nulls in-between. The loudspeaker is positioned in the null of the polar response characteristic that resides between the major lobe and an adjacent side lobe. The microphone apparatus is positioned so that its major lobe is aimed in a direction that is generally perpendicular to the direction that the loudspeaker is aimed at, such as to substantially reduce the acoustic coupling between the loudspeaker and the microphones. Means are provided for increasing the distance between input sound ports of a first-order-gradient (FOG) microphone and thereby improving its sensitivity A pair of such improved FOG microphones is used in assembling a second-order-gradient microphone. Full duplex operation is achieved when a pair of echo cancellers is added to further reduce the coupling between the transmit- and receive-directions of the speakerphone.

U.S. Pat. No. 6,041,127 discloses a technique of producing a response pattern of a microphone array having an adjustable orientation of maximum reception. This is implemented by detecting difference signals between the pairs of the individual microphone output signals, and actuating a selected pair of microphones to receive signals.

A directional microphone system is described in U.S. Pat. No. 5,483,599. The system comprises at least two microphones utilizing a summing means for producing a sum signal of the signals produced by the microphones, a product means for producing a product of the at least two signals, and a mixing means for combining the signals for the presentation to the summing and product means. The mixing and summing means includes a signal time delay means so that at least some of the signals are time delayed before they are summed. Signals coming from directions other than directly perpendicular to the two microphones are attenuated first by the summing means, since they may not be in phase, and secondly by a gain circuit, which is controlled by a multiplier, since the product of signals not in phase falls off rapidly with the increase in the angle away from perpendicular. To emphasize this rejection of signals coming in from an angle, a low-pass filter in conjunction with a rectifier causes the multiplier to function as a cross-correlation mechanism which effectively rejects all incoming signals that are not precisely in phase.

### SUMMARY OF THE INVENTION

There is accordingly a need in the art to facilitate communication between distant locations through transmission/reception of acoustic signals by providing a novel method and system for transmitting and/or receiving acoustic signals with a desired direction.

The main idea of the present invention consists of utilizing an array (generally, at least two) of omnidirectional transmitters and/or receivers of acoustic signals, and processing signals to be transmitted as acoustic signals and/or processing received acoustic signals with a wavelet packet transform model. The model (algorithm) performs spatial filtering of signals received by the acoustic receivers and/or a signal to be transmitted by acoustic transmitters, as the case may be. This filtering consists of suppressing energy components coming from directions other than the desired direction (defined by the subject location relative to the receivers), and/or directional beam forming of a beam to be transmitted by the acoustic transmitting devices such as to be directed substantially in the desired direction (towards the subject). The received signal are thus composed in a way that performs spatial filtering from the desired direction. The desired direction of the lo transmission/reception can be determined utilizing a suitable technique for identifying the relative location of the subject. The Wavelet Packet Transform based approach is a frequency and time domain transform, and has been disclosed for example in the following publications:

Mallat S., “A wavelet tour on signal processing”, Acad. Press, 1998, for example pages 220-228;

Barbara Burke Hubbard, “The World According to Wavelets. The Story of a Mathematical technique in the Mahing”, A. K. Peters, Wellesley, Mass.

Generally speaking, signal processing with the wavelet packet transform model includes decomposing the signal into a matrix of sub-signals, wherein each sub-signal is a base function of frequency and time multiplied by a predetermined coefficient characterizing energy of the respective sub-signal. In order to create a preferred (desired) direction for signal transmission, or collect incoming acoustic signals substantially from a desired direction, the coefficients are optimized in accordance with the desired direction such that the maximal energy in the processed signal is that associated with the desired direction.

There is thus provided according to one aspect of the invention, a method for controlling one or both of transmitting acoustic signals from at least two transmitting devices in a desired direction towards a subject location and receiving acoustic signals propagating in a desired direction from a subject location by at least two receiving devices, the method comprising:

(i) providing data indicative of the desired direction; and

(ii) processing digital signals representative of acoustic signals associated with said at least two devices, said processing comprising applying to the collected signals a selected wavelet packet transform model according to the data indicative of the desired direction to thereby produce a digital output signal shaped such that maximal energy of said output signal is substantially that of the desired direction.

The term “collected digital signals” used herein signifies digital representation of either external signals to be transmitted as acoustic signals through the transmitting devices, or external acoustic signals received by the receiving devices. The term “acoustic signals associated with said at least two devices ” used herein signifies acoustic signals to be transmitted through the transmitting devices, or acoustic signals collected (received) by the receiving devices. It should be understood that the term “direction” actually refers to a line between the transmitting/receiving devices and opposite directions are considered for signal transmission and reception, respectively.

According to one embodiment, the collected signals are digital signals to be transmitted to the subject as acoustic signals through the at least two transmitting devices. In this case, the transmitting devices are operable by the digital output signal to generate and transmit an acoustic signal shaped such that the maximal energy of the transmitted acoustic signal is directed substantially in the desired direction.

According to another embodiment) the collected signals are digital signals representative of acoustic signals received by the receiving devices. These digital signals are thus processed to produce the output digital signal whose maximal energy is that collected substantially from the desired direction (from the subject location). In other words, the processing of the collected signals consists of effective filtering out of the collected signals background noise and/or acoustic signals from directions other than the desired direction.

Generally, the case may be such that an acoustic receiver-subject and/or acoustic transmitter-subject is positioned stationary at a known location with respect to the transmitting/receiving devices, and the regular non-directional transmitting/receiving devices are to periodically transmit/receive acoustic signals to or from the subject. In this case, data indicative of the desired direction is previously determined and stored in the memory utility of the processor.

In most cases, however, the data indicative of the desired direction is to be obtained each time the transmitting/receiving process is to be started. Preferably, this data also has to be dynamically determined during the process.

The data indicative of the desired direction (defined by the location of the subject relative to the transmitting/receiving devices) can be obtained by receiving external acoustic signals including those coming from the subject location, and analyzing the received acoustic signal. Analyzing the received acoustic signals can be aimed at identifying whether the received acoustic signals include signals associated with an authorized subject In this connection, the audio signature of the authorized person is previously determined and stored. Identification of the signature can utilize a wavelet packet transform approach. In this case, the optimal wavelet packet transform model is previously selected and stored. Alternatively, the analyzing of the received acoustic signals can be aimed at determining the audio signature of a specific person. Thus, a person who intends to use a system of the invention actuates the system by starting to speak to enable the location of the direction from which the person is speaking, and determine his/her audio signature. In this case, more than one wavelet packet transform model can be preset in order to select the optimal one in response to the determined audio signature.

Obtaining the data indicative of the desired direction can be based on the generation of an excitation (control) signal to be transmitted from the vicinity of the transmitting/receiving devices to thereby produce a response to the control signal generated at the subject location by an external device (e.g., attachable to a person). By receiving and analyzing the response, the person can be located and the desired direction can be determined. Such a control signal may be an acoustic signal (e.g., ultrasound). A person intending to use a system of the present invention (e.g., phone system) thus carries a suitable acoustic transceiver designed to match the signal generator of the system, or an acoustic reflector At least one of said at least two transmitting devices can be used to transmit the control signal, and the array (at least two) of the receiving devices can be used to receive the response.

As indicated above, the processing of the collected signals with the selected wavelet packet transform model includes providing digital representation of the collected signals and decomposing each of the collected digital signals into a matrix of sub-signals, each being a base function of both frequency and time, multiplied by a predetermined coefficient characterizing the energy component of the respective sub-signal. These coefficients are optimized in accordance with the desired direction to shape the output signal such that the maximal energy is that associated with the desired direction.

As indicated above, the subject (e.g., person) may move with respect to the system during the operational session. Therefore, the system is preferably preprogrammed for dynamically determining the relative position of the subject and dynamically optimizing the coefficients in accordance with the variations of the maximal energy direction.

According to another broad aspect of the present invention, there is provided a system for controlling one or both transmitting acoustic signals in a desired direction towards a subject location and receiving acoustic signals propagating in a desired direction from a subject location, the system comprising:

(a) at least two devices operable to carry out at least one of the transmitting and the receiving of acoustic signals;

(b) a processor connectable to said devices and responsive to collected digital signals associated with said devices, said processor being preprogrammed to process the collected digital signals with a selected wavelet packet transform model in accordance with data indicative of said desired direction, and produce a digital output signal shaped such that maximal energy of said output signal is substantially that of the desired direction.

Preferably, the system also comprises a direction finding utility operable to identify the subject location relative to the system, and thereby obtain data indicative of the desired direction for transmitting and/or receiving acoustic signals by the system substantially in and/or from this direction.

Such a system utilizing only the directional transmission of acoustic signals may be used with an audio set, e.g., TV or radio set A system utilizing only the directional reception of acoustic signals may be used with a computer device, such as a personal computer (e.g., laptop) or PDA, aimed at carrying out speech recognition or voice operation of a specific software application, for example, word processing software, or computer games. A system utilizing both the directional signal transmission and direction signal reception may be used with a phone system (e.g., mobile phone, speakerphone, car phone), or a computer system for carrying out Intercom session, video conference, etc. The term “used with” signifies that the system is either a separate unit connectable to the respective device (e.g., a phone device) through signal transmission (wire-based or wireless), or is a part of the respective device.

Thus, according to yet another broad aspect of the invention, there is provided a system for transmitting acoustic signals substantially in a desired direction and receiving acoustic signals substantially from the desired direction, the system comprising:

a communication utility connectable to a communication network;

an acoustic receiving array;

an acoustic transmitting array;

a processor connectable to the communication utility, the acoustic receiving array, and the acoustic transmitting array, the processor being responsive to digital signals representative of acoustic signals received by the receiving array to process them with a selected wavelet packet transform model in accordance with data indicative of the desired direction and produce an output digital signal to operate the communication utility, said output signal to the communication utility being shaped such that maximal energy of said output signal is that received by the receivers substantially from the desired direction, the processor being responsive to digital signals representative of signals collected by the communication utility to process them with a selected wavelet packet transform model in accordance with the data indicative of the desired direction and produce an output digital signal to operate the acoustic transmitting array, said output signal to the acoustic transmitting array being shaped such that maximal energy of said output signal is directed substantially in the desired direction.

As indicated above, the present invention can be used with a mobile phone device. Mobile communication devices today are small hand-held devices with an RF transceiver incorporated in them. As a result, during use, a relatively high power transmission is emitted close to the human skull. There is accumulating data regarding potential damage of such RF radiation which raises considerable control, voice and number of publications, on the hazardous effect of continuous use of mobile phone devices. The technique of the present invention limits the problem associated with RF radiation by the communication device by providing directional transmission and reception of audio signals. This enables conducting a communication session with there being neither the need to hold the phone device close to the person's head, nor to equip the phone device with additional means for reducing RF radiation.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1A illustrates schematically the system according to one example of the present invention;

FIG. 1B is a flowchart of the process according to the present invention;

FIG. 2 illustrates schematically the system according to another example of the present invention;

FIGS. 3A and 3B illustrate the system according to yet another example of the present invention;

FIG. 4 illustrates a flow diagram of an initial stage in the operation of the system of FIGS. 3A-3B aimed at determining the desired direction of signal transmission/reception; and

FIG. 5 shows the principles of a wavelet packet decomposition process.

### DETAILED DESCRIPTION OF THE INVENTION

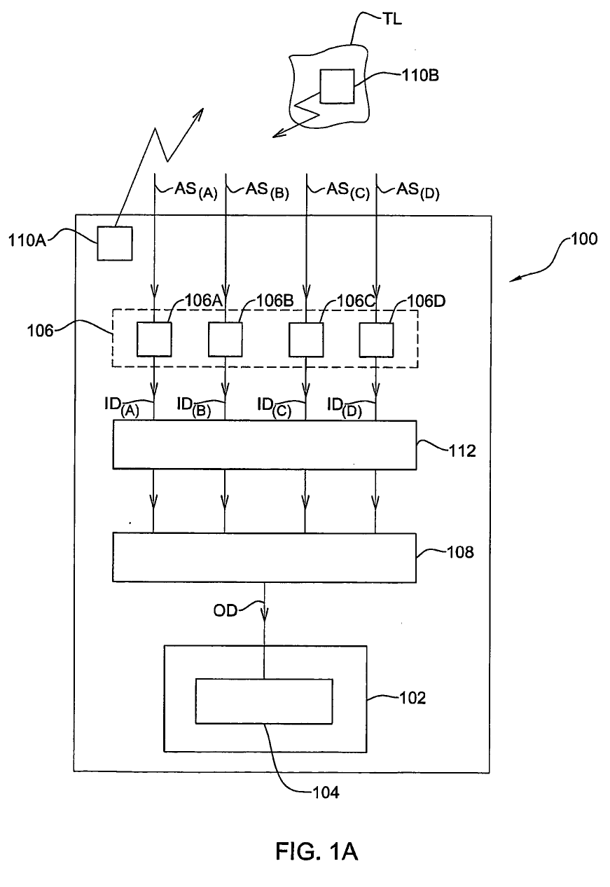

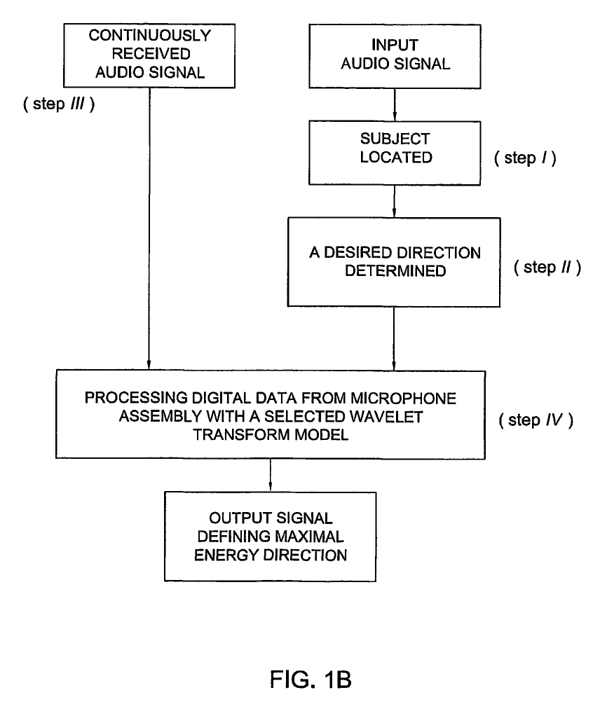

Referring to FIG. 1A, there is schematically shown a system 100 according to one embodiment of the invention. In the present example, the system 100 is used with a personal computer 102 for voice operation of a specific programming utility 104 (e.g., word processing software). The system is to be operated by voice (audio) signals coming from a specific person at a subject location TL.

The system 100 comprises such main constructional parts as a microphone assembly, generally at 106, and a processor 108 (which may be implemented on the CPU of the personal computer) connected to the output of the microphones and preprogrammed to process digital data representative of the received audio signals to thereby control the signal reception process. Also provided in the system 100 is a direction finding utility 110, which may be part of the processor 108 or may include a separate device as in the present example of FIG. 1A The microphone assembly 106 is composed of an array of microphones (generally, at least two microphones, constituting receiving devices for receiving audio signals)—four such microphones 106A, 106B, 106C and 106D being shown in the present example of FIG. 1A. The microphones are regular omni-directional microphones for receiving audio signals (AS_{(A)}, AS_{(B)}, AS_{(C)}, AS_{(D)}) from within the surroundings of the system. The microphones may be arranged in a one- or two-dimensional array (which may be linear or circular), where the distance between two locally adjacent microphones may and may not be the same. The output of the microphones 106 is connected to the processor 108 through an A/D converter 112 to thereby provide digital input data components ID_{(A)}-ID_{(D)} to the processor 108 that are representative of the audio signals AS_{(A)}-AS_{(D)} collected by the microphones, respectively.

The direction finding utility 110 is designed and operable to locate the direction from the subject relative to the system 100 and thereby enable determination of the desired direction for the signal reception. In the present example, the direction finding utility 110 is composed of two remote units 110A and 110B capable of communicating with each other through signal transmission, wherein the unit 110A is incorporated in the system 100, and the unit 110B is positioned at the subject location (e.g., is attached to a person intended for operating the word processing software). For example, the unit 110A may be an ultrasound transceiver, and the unit 110B may be either a similar transceiver matching the transceiver 110A or may be a reflector of ultrasound waves. Generally speaking, the direction finding utility 110 can be implemented by one of the following means:

(2) Passive unit—a miniature retro-directive device 110B (a passive acoustic echo reflector) to be accommodated at the subject location, e.g., attachable to the user, to reflect a control signal (e.g., ultrasound signal, or a very short audio pulse unheard by the human ear) transmitted by the system 100 (through an appropriate transmitting device—unit 111A), wherein the control signal may be encoded to thereby enable the use of a specific control signal for communicating with a specific person.

(3) Active unit—a miniature acoustic transmitter 110B attachable to the user for transmitting a special acoustic signal (audio or ultrasound) unheard by the human ear that is to be received by the microphone assembly of the system 100. The special acoustic signal may be encoded to identify the user.

(4) Active unit—a miniature infrared emitter 110B attachable to the user for transmitting an infrared signal (e.g., encoded signal) that is to be received by an infrared detector 110A.

(5) Software application incorporated within the processor 108 (or another processing utility) and capable of identifying the voice pattern of a speaker. For example, the same microphone assembly 106 may be used for collecting external acoustic signals including those coming from the subject, to be processed by the processor 108. In this case, the speaker may actuate the direction finding utility through the system interface, e.g., press a button and start speaking (e.g., pronouncing a keyword or key phrase) thereby enabling the software to learn and store the voice pattern of the specific speaker, or identify the voice pattern of the specific speaker provided the person's audio signature has been previously determined and stored.

(6) A biometric detecting device, either one-part device incorporated in the system 100, or a two-part device having one part 110A at the system and the other part 110B attachable to a person. Such a device is of the kind capable of identifying the presence of a person in the vicinity of the system 100 by sensing one or more of the person's biometric attributes, such as heartbeat, breath sound or body temperature (infrared radiation).

Having identified the relative location of the subject, data indicative of this location is analyzed to determine the desired direction. The data analysis may utilize any known suitable technique. To this end, the direction finding utility includes a data processing and analyzing utility, which may be part of the processor 108. The data analysis technique may be similar to that disclosed in U.S. Pat. No. 5,600,727. According to this technique, acoustic pulses generated by several loudspeakers are received by each of several microphones, the time-of-flight for each pulse to each microphone is measured, and the distance and angular displacement of each microphone from a predetermined reference are derived. Generally, the data indicative of the desired direction may be obtained by applying Fourier Transform analysis, or any other method based on time delay in signal reception by multiple microphones, to signals received from the identified subject location (e.g., an acoustic signal sent from a transmitter at the subject location or reflected in response to the control signal by an acoustic reflector). Alternatively, the data analysis may include the wavelet packet transform approach, as will be described further below.

It should be noted that if there are multiple sound sources in the surroundings of the system, such as multiple speakers, music, television, radio, or any source of noise, the provision of the direction finding utility 110 enables to locate the required sound source (subject) among the multiple of sources. It should also be noted that location of the subject can be dynamically carried out, e.g., by preprogramming the system to continuously or periodically actuating the operation of the direction finding utility 110, to thereby track the position of the specific person with respect to the system 100.

The processor 108 is preprogrammed to utilize data indicative of a desired direction for signal reception (defined by relative location of the subject) to process digital data representative of the audio signals received by the microphones, and provide an output signal OD characterized by that its maximal energy is substantially that coming in a direction from the subject location TL to the system 100. The processing of the input digital data is based on shaping it in accordance with a selected wavelet packet transform model, as will be described more specifically further below. The so-produced output signal is received by the word processing software 104, thereby increasing signal-to-noise ratio of the signal intended for operating this software, considering noise audio signals coming from directions other than the desired one.

Reference is now made to FIG. 1B illustrating the main operational steps of the system 100, wherein the above-indicated option (4) is used for implementing the direction finding utility 110. Initially (step I), the direction finding utility 110 is actuated, either by the processor 108 to transmit a control signal, or by a person (e.g., by pressing a button on the system 100 and staring speaking), to thereby locate the specific (authorized) person and generate data indicative of his/her location (i.e., of the subject location). The processor 108 receives this data and analyzes it to determine an angle (or angles) defining the maximal energy direction to be created (step II). The data analysis may include the wavelet packet transform approach, as will be described further below, Now, microphones continue receiving audio signals (step III) and generating data indicative thereof. Digital data representative of the audio signals received by the microphones enter the processor 108, which applies a selected wavelet packet transform model to these digital data (step IV) and generates an output signal OD shaped as described above.

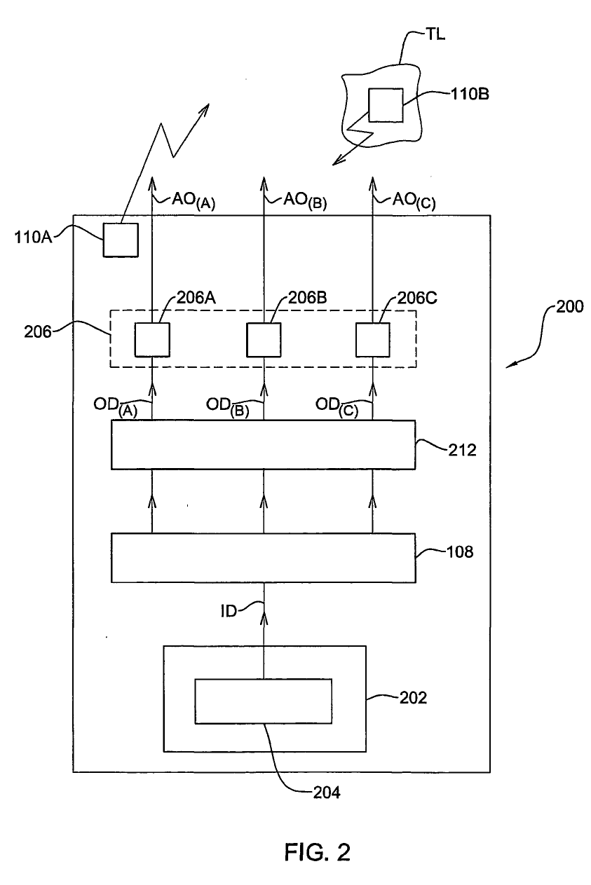

FIG. 2 illustrates a system 200 according to another example of the invention. In order to facilitate understanding, the same reference numbers are used for identifying those components, which are identical in the systems 100 and 200. The system 200 is used with a television (or audio) set 202 for transmitting audio output signals AO_{(A)}, AO_{(B)}, and AO_{(C)} generated by the TV set 202 towards a specific location (subject location) TL. The system 200 comprises a loudspeakers' assembly 206, e.g., composed of three loudspeakers 206A-206C; and a processor 108. The system 200 also comprises a direction finding utility 110 (one or two-part utility as described above). Here, the processor 108 controls the signal transmission process, and is connected to an antenna 204 (constituting a communication utility) of the TV set to receive input collected signals ID that are to be transmitted as audio signals through the loudspeakers, and to the loudspeakers to supply thereto digital data components (signals) OD_{(A)}-OD_{(C)}. The latter are results of processing the collected signal ID with the wavelet packet transform model in accordance with data indicative of a desired direction, and are such that the shape of the entire output signal from the loudspeakers corresponds to the maximal energy propagation in the desired direction, i.e., to the subject location. Here, each loudspeaker is associated with a D/A converter, generally at 212, connected to the processor 108.

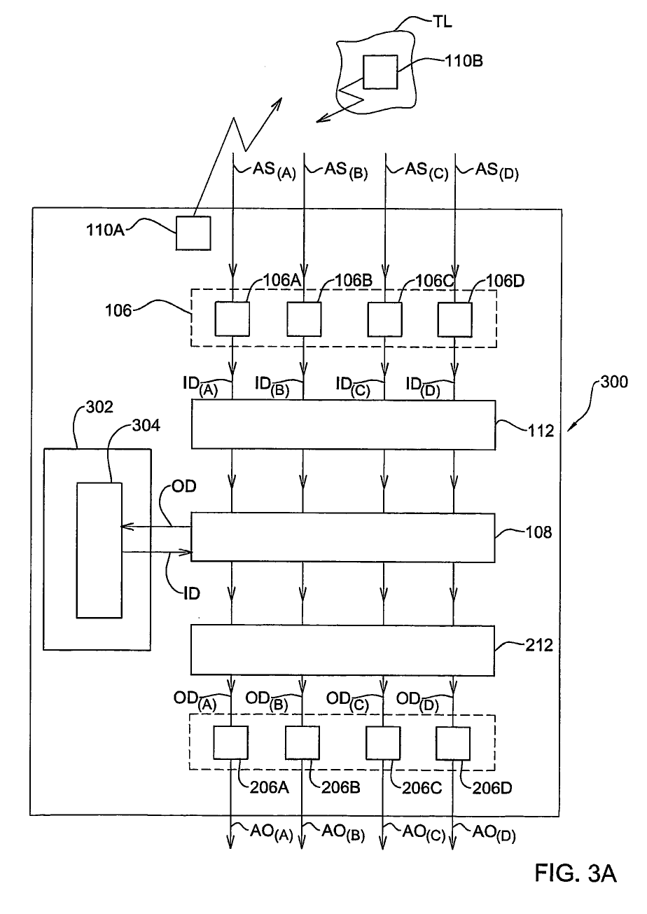

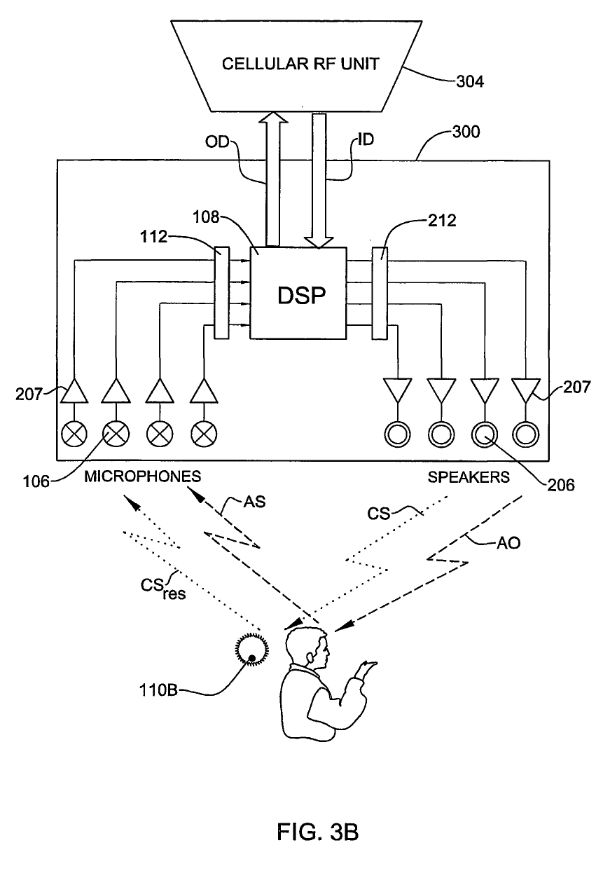

Reference is now made to FIGS. 3A and 3B illustrating a system 300 according to yet another example of the invention. The system 300 is used with a phone device 302, e.g., a mobile phone device. Similarly, the same reference numbers are used for identifying those components, which are identical in the system 100 or 200 and in the system 300. The system 300 comprises a microphones' assembly 106, e.g. composed of four standard telecommunication (semi-directional) microphones 106A-106D, and a loudspeakers' assembly 206, e.g., composed of four standard telecommunication narrow-directional loudspeakers 206A-206D; and a processor 108. The microphones and loudspeakers are associated with corresponding amplifiers, generally at 207. A direction finding utility 110 utilizes a retro-directive unit 110B attached to a person. Here, the processor 108 controls both the transmission and reception processes. The processor 108 is connected to a communication utility 304 of the phone device 302 (e.g., cellular RF unit in a mobile phone or a cable in a telephone) to receive both input signals ID received from a communication network to be transmitted as audio signals through the loudspeakers, and an output signal OD generated by the processor as a result of processing audio signals AS_{(A)}-AS_{(D)} collected by the microphones. The processor 108 is connected to the loudspeakers to supply thereto digital data components (signals) OD_{(A)}-OD_{(D)} resulting from processing the input collected signal ID, and is connected to the microphones to receive digital data components (signals) ID_{(A)}-ID_{(D)} representative of the audio collected signals that are to be processed. The output signals of both kinds, i.e., OD and OD_{(A)}-OD_{(D)}, are obtained by applying a wavelet packet transform model to the processor's input, i.e., ID and ID_{(A)}-ID_{(D)}, and are characterized by the signal shape corresponding to the maximal energy direction, i.e., a direction to or from the subject location. The loudspeakers are associated with a D/A converter 212 connected to the processor 108. Similarly, an A/D converter 112 is interconnected between the processor 108 and the microphone assembly 106. In the present example, the second part of the direction finding utility 110, which generates a control signal CS to be reflected as a response CSᵣₑₛ by the unit 110B, is implemented within the loudspeaker/microphone assemblies operable by the processor 108.

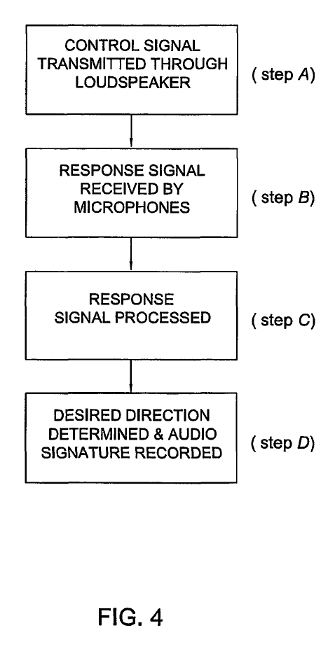

FIG. 4 exemplifies the initial stage in the method of the present invention aimed at determining the relative location of the authorized person (who carried the retro-directive unit) relative to the system 300, i.e. determining a desired location for signal transmission/reception. The processor actuates at least one loudspeaker to transmit a control audio signal (step A) to thereby cause a response signal reflected from the unit 110B, and the microphones receive the response signal (step B). The processor now processes the response signal, namely, its four components collected by the four microphones, respectively (step C). To this end, the processor 108 utilizes reference data stored in its memory and representative of a selected wavelet packet family to use it for processing the response signal, as will be described further below. The result of the processing is indicative of a desired direction for signal transmission/reception, namely, is indicative of an optimal shape of a signal to be produced by the processor. This shape is such that the maximal energy component of the signal is that associated with the desired direction. It should be noted that, alternatively, the person may actuate the processor (e.g., by pressing a specific button on the phone system and start speaking) to thereby enable identification of his/her location (direction) and his/her audio signature for selecting the preferred wavelet packet family to be used for processing input and output signals.

The following is the description of the Beam Forming algorithms used in the system of the present invention. As indicated above, the same algorithm can be used for direction finding as well.

The processing utilizes the so-called Beam Forming utility, which may be realized in general in software or/and in hardware. The beam forming algorithm is essentially destined to shape a signal in accordance with a desired angular distribution of energy in the signal, and consists of applying the so-called software filtering to the input digital signal to produce an output shaped digital signal. The algorithm utilizes the principles of Acoustic Phased Array transmission and wavelet transform theory More specifically, the algorithm utilizes processing of several signal components by applying a wavelet packet transform model to thereby produce phased array transmission/reception in/from a predetermine direction. The wavelet transform theory is known to be a powerful tool for exploring quasi-stationary signals. The wavelet analysis extracts such essential features as frequency bands, including the characteristic frequencies of a signal. Operating with frequency bands instead of individual frequencies has significant advantages when dealing with signals continuously varying in time or transient signals.

Applying a Wavelet Packet Transform (WHT) to a signal f(t) of length 2^{J} generates a decomposition of the signal into a sum of n waveforms:

$$f ( t ) = {\sum }_{n = 1}^{{2}^{J}} {ω}_{0}^{0} ( n ) φ ( t - n ) = {\sum }_{n = 1}^{{2}^{J - 1}} {ω}_{0}^{l} ( n ) φ ( {2}^{- l} t - n ) + {\sum }_{m = 1}^{l} {\sum }_{n = 1}^{{2}^{J - m}} {ω}_{1}^{m} ( n ) ψ ( {2}^{- m} t - n )$$

wherein {\overline{ω}₀¹(n)}ₙ₌₁2^{(J-1)} is a block of correlation coefficients of signal with the l-times scaled and shifted low frequency wavelet (“father” wavelet) φ; and {\overline{ω}₁^{m}(n)}ₙ₌ₗ2^{(J-m)} is a block of correlation coefficients of signal with the m-times scaled and shifted high frequency wavelet (“mother” wavelet) Ψ. Each block is related to a single testing waveform.

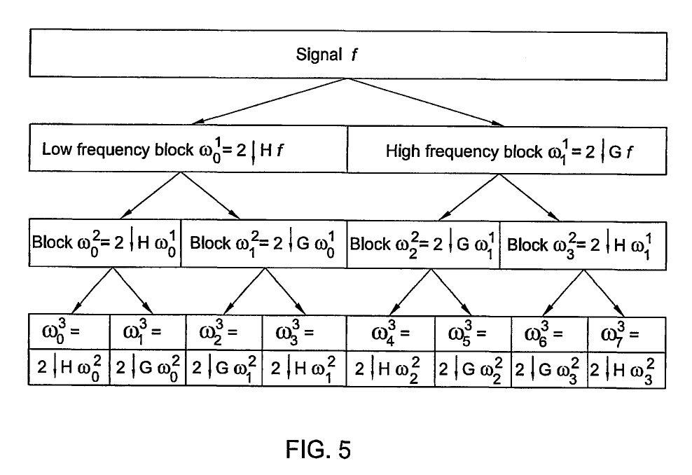

The main stages of the decomposition process are illustrated FIG. 5. Thus, the transform involves (m+l) waveforms, whose spectra cover the whole frequency domain, and splits the spectra in a logarithmic manner. Each decomposition block is linked to a certain frequency band.

A wavelet transform, in contrary to Fourier Transform, operates directly with frequency bands. An assumption is made that the dominating frequencies of a person's voice are known in advance. Hence, Φ_{L}^{J} is a waveform from a specific (selected) wavelet packet family, related to this frequency band, while J denotes the decomposition level L=2^{J} being the number of blocks of this level.

Considering X^{m} being the signal obtained by the m^{th} microphone in the assembly 106 (e.g., a linear or a circular assembly), each signal X^{m} is decomposed into 2^{N} sub-signals: X^{m}=(X^{m}₁, X^{m}₂, . . . , X^{m}₂N) according to the set of base functions, i.e., correspondingly to waveforms Φ_{J}^{L}(t−tᵢ), where tᵢ=i2^{-(N-L)}t₀, i=1, . . . , 2^{N-L}t₀, i=1, . . . , 2^{N-L} and t₀ being the duration of the signal. The coefficients {c^{m}(i)}2ᵢ₌₁^{N-L} are the relative weights of each waveform, respectively.

Thus, for an array of microphones in the assembly 106, the input signal ID received by the microphone assembly can be generally expressed in terms of WPT as follows:

$${E}_{c}^{ϕ} = {\sum }_{n = 1}^{N} {\sum }_{i = 1}^{{2}^{N - L}} {c}^{n} ( i ) {φ}_{L}^{J} ( t - {t}_{i} - {t}_{c}^{n} )$$

For a circular case, t_{c}ⁿ is the time delay introduced by the wavelet-based processing to the signal received by the n^{th} microphone in the circular array, and is further defined as a function of the azimuth's angle to the signal source φ (which is called “subject” here):

$$\begin{matrix}{t}_{c}^{n} ( ϕ ) = \frac{2}{c} ( 1 - cos ( {ϕ}_{n} - ϕ ) ) , & n = 1 , … , N\end{matrix}$$

In case of a linear array, tᵢ^{m} is the time delay introduced by the wavelet-based processing to the signal received by the m^{th} microphone, and is defined as a function of the elevation angle to the source θ (subject):

$${t}_{l}^{m} ( θ ) = \frac{M - m}{c} cos θ , \qquad m = 1 , … , M$$

The “energy” of the received signal, which is the sum of the “energies” of all the sub-signals at all the microphones in the assembly, is dependent on the elevation angle Θ or the azimuth angle φ to the signal source (subject location), in the linear and circular arrays, respectively. Thus, the direction to the subject location, defined by the angle φ₀ or θ₀ is determined by optimizing the expression of the total “energy” of the received beams, ∥E_{c}^{φ}0(·)∥1₂ or ∥EL_{θ}0(·)∥1₂, as a function of φ or Θ, respectively, to be the maximal.

It should be noted that, based on the physical reversibility principle of signal receiving and transmitting, the same algorithm is used to process signals received by the microphones and to process signal received from the antenna (generally, communication utility), to produce a directional output audio signal. The term “output” refers to the processor's output and not always the system output.

It should be understood that the family of waveforms Φ_{L}^{J} could be chosen from a variety of known wavelet families, such as the spline, Haar and Coifman families. In order to make the optimal selection, preliminary tests are to be applied to the voice of an authorized person (“the system owner”) to enable fitting typical persons' voice with the best wavelet family, i.e., to select that wavelet family providing the best optimization possibilities of the system.

In principle, a variety of waveforms can be stored as reference data in the system (processor's memory) to better optimize the system's performance. Practically, one wavelet family may be found to be the best fit for most personal audio samples, e.g., the spline wavelet family, thus may suffice for practical use.

Those skilled in the art will readily appreciate that various modifications and changes can be applied to the embodiments of the invention as hereinbefore exemplified without departing from its scope defined in and by the appended claims. The present invention can be used with an acoustic signal receiver device, such as a personal computer, to allow voice operation of a specific software application, with an acoustic signals transmitter device, such as TV or radio set, as well as a system intended for both transmission and reception of acoustic signals, such as a phone device, computer device, etc. The present invention utilizes data indicative of a desired direction for signal transmission/reception, which can be obtained either by using suitable known means for identifying the subject location (e.g., acoustic retro-directive elements), and/or by using the wavelet-based processing of the input acoustic signal.

1. A method for controlling communication between acoustic devices and a subject location, the method utilizing signal processing by a wavelet packet transform model and being characterized in:.
(i) processing first digital signals representative of external acoustic signals received by the at least two acoustic receiving devices to identify a desired communication direction associated with the subject location, and using data indicative of the desired direction for optimizing parameters of a selected wavelet packet transform model to be used for controlling the communication between at least two acoustic transmitting devices and the subject location; and
(ii) controlling said communication by processing second digital signals representative of signals that are to be transmitted as acoustic signals through the at least two acoustic transmitting devices, said processing comprising applying to said second digital signals the optimized selected wavelet packet transform model to thereby produce a second digital output signal to operate said at least two acoustic transmitting device, said second digital output signal having an optimal shape with a desired angular distribution of energy in said signal such that a maximal energy component thereof is substantially that of the desired direction, while its energy components associated with directions outside said desired directions are substantially suppressed.

2. The method according to claim 1, comprising controlling receipt by the at least two acoustic receiving devices of the external acoustic signals propagating in the desired direction from the subject location, while substantially preventing receipt of acoustic signals coming from outside said desired direction, said controlling comprising processing of the first digital signals representative of the external acoustic signals received by said at least two receiving devices by applying to said first digital signals the optimized selected wavelet packet transform model to thereby produce a first digital output signal indicative of the received acoustic signals and having an optimal shape such that a maximal energy component thereof is substantially that of the desired direction, while its energy components associated with directions outside said desired direction are substantially suppressed.

3. The method according to claim 1 or 2, comprising dynamically identifying the desired communication direction and optimizing the wavelet packet transform model in accordance with the communication direction.

4. The method according to any one of claims 1 to 3, comprising:
receiving acoustic signals by the at least two acoustic receivers,
analyzing the received acoustic signals to identify whether said received acoustic signals include signals associated with an authorized subject;
upon identifying that the received acoustic signals include signals associated with the authorized subject, processing said received signals to determine direction of the signals coming from the subject, said direction being the desired direction.

5. The method according to any one of preceding claims wherein
actuating reception of the acoustic signals coming from the subject;
processing the received acoustic signals to obtain the data indicative of the desired direction.

6. The method according to claim 4 or 5, wherein said received acoustic signals are voice signals of the authorized subject, the method also comprising storing data indicative of the audio signature of the authorized subject.

7. The method according to claim 5, wherein the actuating of reception of the acoustic signals comprises generating and transmitting a control signal from a vicinity of said at least two acoustic receiving devices to thereby produce a response to said control signal generated by an external unit at the subject location.

8. The method according to any one of preceding claims, wherein said second digital signals to be processed are representative of collected external signals that are received by a communication utility and are to be transmitted through the at least two acoustic transmitting devices in the form of acoustic signals.

9. The method according to any one of preceding claims, wherein the first digital output representative of said first digital signals is used to operate a communication utility to transmit signals indicative of the acoustic signals received substantially from the desired direction.

10. The method according to any one of preceding claims, wherein said processing of the digital signals with the selected wavelet transform model comprises decomposing each of the digital signals into a matrix of sub-signals, each lo being a base function of both frequency and time multiplied by a predetermined coefficient, which characterizes energy of the respective sub-signal, the coefficients being predetermined in accordance with the desired direction, such that the maximal energy of the output digital signal is associated substantially with the desired direction.

11. A system for controlling communication between acoustic devices and a subject location, the system comprising acoustic devices and a processor system connectable to the acoustic devices and operable to process signals with a wavelet packet transform model, the device being characterized in:
(a) said acoustic devices comprises at least two acoustic transmitting devices operable to transmit data indicative of collected digital signals, coming from a communication utility, as acoustic output signals, and at least two acoustic receiving devices operable to receive external acoustic signals and generate digital signals representative thereof;
(b) said processor system is connectable to the communication utility, and comprises a beam forming utility preprogrammed to be responsive to input digital signals representative of external acoustic signals received by the at least two acoustic receiving devices to identify a desired communication direction associated with the subject location, and to use data indicative of the desired direction for optimizing parameters of a selected wavelet packet transform model, and preprogrammed for using the optimized wavelet packet transform model for controlling the communication between said at least two acoustic receiving devices and at least two acoustic transmitting devices and the subject location, by selectively processing with the optimized selected wavelet packet transform model first digital signals representative of external acoustic signals received by the at least two acoustic receiving devices or second digital signals representative of signals that are to be transmitted as acoustic signals through the at least two acoustic transmitting devices, to selectively produce, respectively, a first digital output signal representative of the external acoustic signals to operate the communication utility and a second digital output signal representative of the digital signals coming from the communication utility to operate said at least two acoustic transmitting devices, each of the first and second digital output signals having an optimal shape in accordance with a desired angular distribution of energy in said output signal such that a maximal energy of the output signal is substantially that of the desired direction, while energy components of said signal associated with directions outside the desired direction are substantially suppressed.

12. The system according to claim 11, wherein said processor system comprises a direction finding utility connectable to the at least two acoustic receiving devices and operable to process the digital representation of the received acoustic signals and obtain said data indicative of the desired communication direction and optimize the parameters of the selected wavelet packet transform model.

13. The system according to claim 12, wherein said direction finding utility comprises a data processing and analyzing utility for receiving the digital representation of the external acoustic signals, determining whether said acoustic signals include signals correlating with a predetermined signature, and upon identifying the correlation, locating the direction from which the correlating acoustic signals come and processing the received acoustic signals, to thereby determine the data indicative of the desired direction.

14. The system according to claim 12, wherein said direction finding utility comprises a data processing and analyzing utility for receiving the digital representation of the external acoustic signals, and processing and analyzing said received acoustic signals to locate the direction from which the acoustic signals come, and create a corresponding signature, to thereby enable selecting a corresponding wavelet transform model to be used by said processor to generate the output signal in accordance with the desired direction.

15. The system according to claim 12, wherein said direction finding utility comprises:
a signal transceiver assembly for transmitting a control signal to thereby produce a response to said control signal generated by an external device at the subject location, and for receiving said response; and
a processing and analyzing utility for processing the received response to locate the subject and determine the desired direction.

16. The system according to claim 15, wherein said signal transceiver assembly includes said at least two receiving devices.

17. The system according to claim 15, wherein said signal transceiver assembly includes at least one of said at least two transmitting devices.

18. The system according to any one of claims 11 to 17, wherein said at least two receiving devices are microphones.

19. The system according to any one of claims 11 to 18, wherein said at least two transmitting devices are loudspeakers.

20. The system according to any one of claims 11 to 19, being a part of a computer system, said processor system being connected to a voice operated programming utility.

21. The system according to any one of claims 11 to 19, being a part of an audio set.

22. The system according to claim 11, being a part of a communication system intended for wire- or wireless communication with another communication system through a network.

23. The system according to claim 11, wherein said communication utility is connectable to a communication network.
